(19) United States
(12) Patent Application Publication
(10) Pub. No.: US 2025/0265088 A1
(43) Pub. Date: Aug. 21, 2025

(54) COMPILER GENERATED HYPERBLOCKS IN A PARALLEL ARCHITECTURE WITH COMPUTE SLICES

(71) Applicant: Ascenium, Inc., Mountain View, CA (US)

(72) Inventors: Peter Aaser, 1394 Nesbru (NO); Hans Olle Viktor Fredriksson, 0187 Oslo (NO)

(73) Assignee: Ascenium, Inc., Mountain View, CA (US)

(21) Appl. No.: 19/053,495

(22) Filed: Feb. 14, 2025

Related U.S. Application Data
(60) Provisional application No. 63/744,394, filed on Jan. 13, 2025.
(60) Provisional application No. 63/659,401, filed on Jun. 13, 2024.
(60) Provisional application No. 63/642,391, filed on May 3, 2024.
(60) Provisional application No. 63/571,483, filed on Mar. 29, 2024.
(60) Provisional application No. 63/554,233, filed on Feb. 16, 2024.

(51) Int. Cl. G06F 9/38; G06F 8/41; G06F 9/30

(52) U.S. Cl. CPC G06F 9/3804; G06F 8/433; G06F 9/30101

(57) ABSTRACT

Techniques for parallel generation of blocks using a compiler are disclosed. A processing unit comprising compute slices, barrier register sets, a control unit, and a memory system is accessed. Each compute slice includes an execution unit and is coupled to other compute slices by a barrier register set. A compiler evaluates a compiled program that includes basic blocks, based on a control flow graph. A first hyperblock is created from at least two basic blocks. One or more branch instructions are replaced with skip instructions that direct instruction execution between basic blocks in the hyperblock. A first slice task is allocated to a first compute slice. A second slice task is allotted based on branch prediction. Pointers to the first compute slice and the second compute slice are initialized. The compiled program is executed, beginning with the first compute slice.

### RELATED APPLICATIONS

This application claims the benefit of U.S. provisional patent applications “Compiler Generated Hyperblocks In A Parallel Architecture With Compute Slices” Ser. No. 63/554,233, filed Feb. 16, 2024, “Local Memory Disambiguation For A Parallel Architecture With Compute Slices” Ser. No. 63/571,483, filed Mar. 29, 2024, “Global Memory Disambiguation For a Parallel Architecture With Compute Slices” Ser. No. 63/642,391, filed May 3, 2024, “Memory Dependence Prediction In A Parallel Architecture With Compute Slices” Ser. No. 63/659,401, filed Jun. 13, 2024, and “Code Translation And Forwarding With Compute Slices” Ser. No. 63/744,394, filed Jan. 13, 2025.

Each of the foregoing applications is hereby incorporated by reference in its entirety.

### FIELD OF ART

This application relates generally to compiling and more particularly to compiler generated hyperblocks in a parallel architecture with compute slices.

### BACKGROUND

Data that is collected and processed by any organization is often at top of the list of its most valuable and highly protected assets. Sets of collected data, or “datasets,” are typically vast and unstructured, thus presenting processing challenges. The datasets are processed to achieve organizational purposes including commercial, educational, governmental, medical, research, or retail purposes, to name only a few. Some datasets are analyzed for forensic and law enforcement purposes. Large and complex computational resources are required to process the organizational datasets, irrespective of organizational size or global reach. The computational resources include processors, data storage units, networking and communications equipment, telephony, power conditioning units, HVAC equipment, backup power units, and other essential equipment. The computational resources consume vast amounts of energy and produce prodigious heat, thereby necessitating energy source management. These resources are located in special-purpose installations that are often high-security installations. These installations less resemble traditional office buildings than high-security bases or even vaults. Not all organizations require vast computational equipment installations. However, all strive to provide resources to meet their data processing needs as quickly and cost effectively as possible.

A wide variety of processing jobs are executed to support organizational operations. The processing jobs include computing statements of accounts, executing billing and payroll, processing tax payments and returns, determining election results, controlling experiments, analyzing research data, and generating academic grades, among others. Computational resources are consumed by processing jobs executed in installations that typically operate 24×7×365. The types of data processed derive from the organizational missions. These processing jobs must be executed quickly, accurately, and cost effectively. The processed datasets can be very large and unstructured, thereby saturating conventional computational resources. Finding a particular data element can require the processing of an entire dataset. Effective dataset processing enables rapid and accurate identification of potential customers, or finetuning production and distribution systems, among other results that yield a competitive advantage to the organization. Ineffective processing wastes money by losing sales or failing to streamline a process, thereby increasing costs.

Data collection techniques are implemented by organizations to amass their data. The data is collected from various and diverse categories of individuals. Legitimate data collection techniques include “opt-in” strategies, where an individual signs up, creates an account, registers, or otherwise actively and willingly agrees to participate in the data collection. Some techniques are legislative, where citizens are required by a government to obtain a registration number to interact with government agencies, law enforcement, emergency services, and others. At other times, the individuals are unwitting subjects of data collection. Still other data collection techniques are more subtle or are even completely hidden, such as tracking purchase histories, visits to various websites, button clicks, and menu choices. Data can and has been collected by theft. Irrespective of the techniques used for the data collection, the collected data, if processed rapidly and accurately, is highly valuable to the organizations.

### SUMMARY

To greatly improve computer processing efficiency and data throughput, a compiled program can be processed using one or more processing units. The processing units include compute slices, barrier register sets, a control unit, and a memory system. The processing units can further include multicycle elements for multiplication, division, and square root computations; load-store units; arithmetic logic units (ALUs); storage elements; scratchpads; and other components. The components can communicate among themselves to exchange data, signals, and so on. A compiler evaluates a compiled program. The evaluating is based on a control flow graph (CFG). The compiler creates a first hyperblock that includes at least two basic blocks. The creating includes replacing one or more branch instructions with one or more skip instructions. The one or more skip instructions direct instruction execution between the at least two basic blocks in the first hyperblock. The control unit allocates a first slice task to a first compute slice, where the first slice includes the first hyperblock. The control unit allots a second slice task to a second compute slice, where the allotting is based on branch prediction logic within the control unit. The second slice is coupled to the first slice by a barrier register. Pointers that include a head pointer and a tail pointer are initialized. The head pointer points to the first compute slice and the tail pointer points to the second compute slice. The compiled program is executed, beginning with the first compute slice.

A processor-implemented method for computer processing is disclosed comprising: accessing a processing unit comprising a plurality of compute slices, a plurality of barrier register sets, a control unit, and a memory system, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices; evaluating, by the compiler, a compiled program, wherein the compiled program includes a plurality of basic blocks, wherein the evaluating is based on a control flow graph (CFG); creating, by the compiler, a first hyperblock, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock; allocating a first slice task, by the control unit, to a first compute slice in the plurality of compute slices, wherein the first slice task comprises the first hyperblock that was created by the compiler; allotting a second slice task, by the control unit, to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets; initializing pointers, wherein a head pointer points to the first compute slice, and wherein a tail pointer points to the second compute slice; and executing the compiled program, wherein the executing begins at the first compute slice.

Further embodiments include generating a first performance estimate, by the compiler, of executing the first hyperblock on the first compute slice. The first performance estimate can be based on compute computational resource usage such as compute cycles and memory accesses. Further embodiments include comparing the first performance estimate to a second performance estimate, wherein the second performance estimate is based on executing the at least two basic blocks on the processing unit, wherein the executing includes at least two compute slices in the plurality of compute slices, and wherein one or more dependencies are passed between the at least two compute slices by at least one barrier register set in the plurality of barrier register sets. The higher performance estimate can be chosen, where the higher performance choice executes the hyperblock or the two or more basic blocks faster.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for compiler generated hyperblocks in a parallel architecture with compute slices.

FIG. 2 is a flow diagram for creating hyperblocks in a parallel architecture with compute slices.

FIG. 3 is a system block diagram for compute slice control.

FIG. 4 illustrates a system block diagram for a ring configuration of compute slices.

FIG. 5 is an example of a compiler generating a hyperblock with skip instructions.

FIG. 6 is an execution example of separate basic blocks on a parallel architecture with compute slices.

FIG. 7 is an execution example of a hyperblock on a parallel architecture with compute slices.

FIG. 8 is an example of identifying a sub-CFG.

FIG. 9 is a system diagram for compiler generated hyperblocks in a parallel architecture with compute slices.

### DETAILED DESCRIPTION

The processing of immense, varied, and often unstructured datasets supports a wide variety of organizational missions and purposes. The organizations include commercial, educational, governmental, medical, research, or retail ones, to name only a few. The datasets can also be analyzed for law enforcement and forensic purposes. Computational resources are specified, configured, and deployed by the organizations to meet critical organizational needs. The organizations range in size from sole proprietor operations to large, international organizations. The computational resources include processors, data storage units, networking and communications equipment, telephony, power conditioning units, HVAC equipment, and backup power units, among other essential equipment. Further, energy resource management is critical since the computational resources consume prodigious amounts of energy and produce copious heat. The computational resources are housed in special-purpose, high reliability and frequently high-security installations. The magnitude of the computational resources can vary by organization, but all organizations endeavor to provide resources to meet their data processing needs as quickly and cost effectively as possible.

Modern day organizations have an ever-growing need for highly reliable and efficient compute resources. The rise in the use of machine learning, and especially of large language models, has further compelled IT departments to provide critical compute resources to engineering, scientific, and business units of organizations. Data mining, image processing, genomic sequencing, autonomous vehicle technology, and virtual reality technology are among the many technologies that have propelled the need for advanced computational capabilities. In response, computer architectures have attempted to meet this need by increasing parallelism, increasing clock speeds, and proposing various architectures and extensions to provide task-specific processing. Advanced computational technologies and architectures will be needed to provide additional compute power to serve current and next generation applications.

To meet the high-performance needs of the many and diverse applications, a processor-implemented method for compiling is disclosed. High-performance computer execution is enabled by compiler-generated hyperblocks in a parallel architecture with compute slices. A processing unit comprising a plurality of compute slices, a plurality of barrier register sets, a control unit, and a memory system is accessed, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices. A compiled program is evaluated by the compiler, wherein the compiled program includes a plurality of basic blocks, wherein the evaluating is based on a control flow graph (CFG). A first hyperblock is created by the compiler, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock. The control unit allocates a first slice task to a first compute slice in the plurality of compute slices, wherein the first slice task comprises the first hyperblock that was created by the compiler. The control unit allots a second slice task to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. The compiled program is executed, wherein the executing begins at the first compute slice.

The first hyperblock allocated to the first compute slice can include one or more skip instructions that replaced one or more branch instructions. A first skip instruction within the one or more skip instructions associated with the first hyperblock includes a conditional operation. The first hyperblock is executed, by the first compute slice, without a prediction of the conditional operation. The prediction of the conditional operation may not be performed based on processing requirements of the first hyperblock. Each side of the conditional operation can be preprocessed ahead of the conditional operation being evaluated. When the conditional operation is evaluated, the correct or taken side of the conditional operation can continue to be executed, while the one or more untaken sides of the conditional operation can be terminated and flushed. The first hyperblock is executed, by the first compute slice, with a prediction of the conditional operation, wherein the prediction is based on the branch prediction hardware within the first compute slice. The branch prediction hardware can predict the side of the branch operation that will likely be taken and can preprocess the predicted taken side ahead of the conditional operation being determined.

The allocating and the allotting can be based on one or more performance estimates. The compiler generates a first performance estimate of executing the first hyperblock on the first compute slice. The performance estimate can be based on numbers of cycles, memory accesses, elapsed time, and so on. The first performance estimate is compared to a second performance estimate, wherein the second performance estimate is based on executing the at least two basic blocks on the processing unit, wherein the executing includes at least two compute slices in the plurality of compute slices, and wherein one or more dependencies are passed between the at least two compute slices by at least one barrier register set in the plurality of barrier register sets. By comparing the first and the second performance estimates, the better performance estimate can be used to allocate and allot the first slice task to the first compute slice and the second compute task to the second compute slice. Here, the better performance estimate uses fewer computational resources, executes in fewer cycles or less elapsed time, and so on.

Programs that are executed by the compute slices within the processing unit can be associated with a wide range of applications. The applications can be based on data manipulation, such as image, video, or audio processing applications; AI and machine learning applications; business applications; data processing and analysis; and so on. The tasks that are executed can perform a variety of operations including arithmetic operations, shift operations, logical operations including Boolean operations, vector or matrix operations, tensor operations, and the like. The subtasks can be executed based on branch prediction, operation precedence, priority, coding order, amount of parallelization, data flow, data availability, compute element availability, communication channel availability, and so on. Slice tasks that comprise a compiled program are generated by a compiler. The compiler can include a general-purpose compiler, a hardware description-based compiler, a compiler written or “tuned” for the specific number of compute slices in the processor unit, a constraint-based compiler, a satisfiability-based compiler (SAT solver), and so on. Control is provided to the hardware by the control unit which allocates slice tasks to compute slices. The control unit can include branch prediction hardware. The allocating can be based on the branch prediction hardware. A branch instruction can require evaluating an expression. The expression can include a logical expression, a mathematical expression, and so on. The control unit can allocate code (or a slice task) associated with a predicted branch outcome on a successor compute slice speculatively before the operands of the logical expression are known. Once issued, the slice tasks execute independently from the control unit and other compute slices until they are either halted by the control unit, indicate an exception, finish executing, etc. When the operands for the logical expression are known, the control unit can check that the code running on the successor compute slice task is a next sequential slice task in the compiled program. The checking can be based on execution of the first compute slice. If the second slice task is the next sequential slice task, then execution can proceed. If the successor slice task is not the next sequential slice task, then results from the successor compute slice are discarded. All further downstream compute slices can also be discarded.

The compute slices within the processing unit can be implemented with central processing units (CPUs), graphics processing units (GPUs), application specific integrated circuits (ASICs), field programmable gate arrays (FPGAs), processor cores, or other processing components or combinations of processing components. The compute slices can include heterogeneous processors, homogeneous processors, processor cores within an integrated circuit or chip, etc. The compute slices can comprise one or more RISC-V™ processors. The compute slices can be coupled to local storage, which can include load-store units, local memory elements, register files, cache storage, etc. The cache, which can include a hierarchical cache such as an L1, L2, and L3 cache, can be used for storing data such as intermediate results, compute element operations, and the like. Any level of cache (e.g., L1, L2, L3, etc.) can be shared by two or more compute slices. The various elements of the processing unit can further include elements within an integrated circuit, elements within an application specific integrated circuit (ASIC), elements programmed within a programmable device such as a field programmable gate array (FPGA), and so on. The processing unit can include homogeneous or heterogeneous processors. The coupling of each compute slice to a successor compute slice and a predecessor compute slice by a barrier register set enables data communication between compute slices. Thus, the control unit can control data flow between the compute slices and can further control data commitment to the barrier register set and to memory outside of the processing unit.

A first slice task is allocated by the control unit to a first compute slice in the plurality of compute slices. The first slice task comprises a hyperblock created from two or more basic blocks by the compiler. The creating includes replacing one or more branch instructions with one or more skip instructions, wherein the one or more skip instructions direct instruction execution between the at least two basic blocks in the first hyperblock. A second slice task is allotted, by the control unit, to a second compute slice in the plurality of compute slices. The second slice task comprises at least one basic block within the plurality of basic blocks. The allotting is based on branch prediction logic within the control unit. The second compute slice is coupled to the first compute slice by a first barrier register set in the plurality of barrier register sets. The first barrier register set enables unidirectional communication between the first compute slice and the second compute slice. Thus, the first compute slice can write to the first barrier register set and the second compute slice can read from the first barrier register set. Pointers are used and initialized to determine which compute slices are issued to the first slice task and the second slice task. Pointers that point to compute slices are initialized. A head pointer points to the first compute slice, and a tail pointer points to the second compute slice. The head pointer and the tail pointer can be updated based on slice task execution status, conditional operation outcome determination, and so on. A compiled program is executed, where the executing begins at the first compute slice. Executing multiple slice tasks on two or more compute slices enables parallelized operations. The parallelized operations enable parallel execution of the first slice task and the second slice task. The second slice task is the predicted outcome of the conditional operation. The parallelized operations can include primitive operations that can be executed in parallel. A primitive operation can include an arithmetic operation, a logical operation, a data handling operation, and so on.

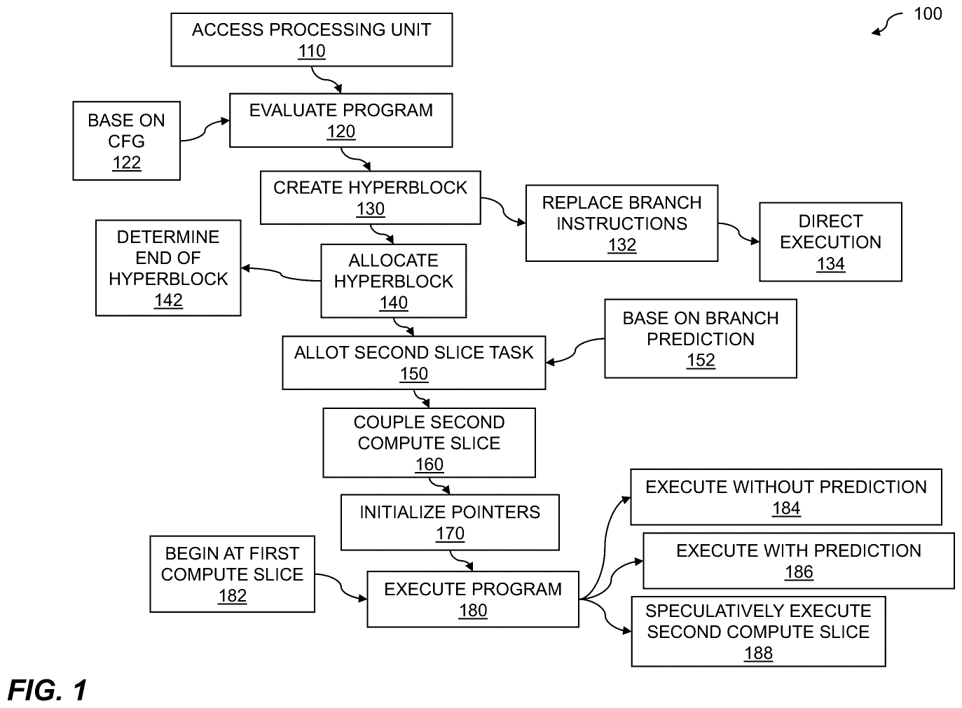

FIG. 1 is a flow diagram for compiler generated hyperblocks in a parallel architecture with compute slices. Compute slices within a processing unit can be issued blocks of code for execution, where the blocks of code are called slice tasks. The slice tasks can be associated with a compiled program. The compiled program, when executed, can perform a variety of operations associated with data processing. The processing unit can include elements such as barrier register sets, a control unit, and a memory system. The processing unit can further interface with other elements such as ALUs, memory management units (MMUs), GPUS, multicycle elements (MEMs), and so on. The operations can accomplish a variety of processing objectives such as application processing, data manipulation, data analysis, modeling and simulation, and so on. The operations can accomplish artificial intelligence (AI) applications such as machine learning. The operations can manipulate a variety of data types including integer, real, and character data types; vectors, matrices, and arrays; tensors; etc.

The flow 100 includes accessing 110 a processing unit comprising a plurality of compute slices, a plurality of barrier register sets, a control unit, and a memory system. Each compute slice within the plurality of compute slices includes at least one execution unit and is coupled to a successor compute slice and a predecessor compute slice by a barrier register set in the plurality of barrier register sets. The barrier register set provides for communication of data between successive compute slices. The compute slices can be based on or can include a variety of types of processors. The compute slices can include central processing units (CPUs), graphics processing units (GPUs), processors or processor cores within application specific integrated circuits (ASICs), processor cores programmed within field programmable gate arrays (FPGAs), and so on. In embodiments, compute slices within the processing unit have identical functionality. In other embodiments, the compute slices within the processing unit have different functionality. The barrier register sets to which the compute slices can be coupled can enable data transfer between compute slices. The data transfer enabled by the barrier register sets can be unidirectional. The coupling compute slices to successor compute slices enables clustering of compute resources; sharing of array elements such as cache elements, multiplier elements, or ALU elements; and the like.

The compiler can include C, C++, or another language. The compiler can include a compiler written especially for the processing unit. The processing unit can run code written in an interpreted language such as Python. The compiler can be used to generate one or more blocks of code or slice tasks that can be mapped, by the control unit, to the compute slices. The slice tasks are assigned to one or more compute slices. Depending on the type and size of a task that is compiled for execution on the processing unit, one or more of the compute slices can execute slice tasks, while other compute slices are unneeded by the particular task. A compute slice that is unneeded can be marked as idle. An idled compute slice requires no data and no further information. The idling of a compute slice can be accomplished using a control bit. The idling of compute slices within the processing unit can decrease power consumption of the processing unit. The slice tasks that are generated by the compiler can include a conditionality such as a branch. Each slice task can include one or more branch instructions. The branch can include a conditional branch, an unconditional branch, etc.

The flow 100 includes evaluating 120, by the compiler, a compiled program, wherein the compiled program includes a plurality of basic blocks. The evaluating the compiled program can include determining computational resource requirements such as basic block size and processing capabilities, numbers of memory access operations, communications requirements, and so on. In the flow 100, the evaluating is based on a control flow graph (CFG) 122. The control flow graph can include a graphical representation of the various paths that might be taken during execution of the basic blocks associated with the compiled program. The CFG can indicate basic blocks that must be executed in series due to data dependencies, basic blocks that can be executed in parallel due to data independence, and the like. The CFG can show locations of conditional operations within the compiled code. The conditional operations can include branch instructions.

The flow 100 includes creating, by the compiler, a first hyperblock 130. The first hyperblock can be formed from the basic blocks. The hyperblock can be allocated to, and executed by, a compute slice in the processor unit. The first hyperblock includes at least two basic blocks within the plurality of basic blocks that were evaluated. In practice, a special type of hyperblock, called a degenerate hyperblock, can comprise a single basic block within the CFG. A degenerate hyperblock can be allocated to, and executed by, a compute slice in the processor unit. In the flow 100, the creating includes replacing 132 one or more branch instructions with one or more skip instructions. A skip instruction can selectively skip a basic block within a hyperblock based on a conditional operation. In embodiments, a first skip instruction within the one or more skip instructions can include a conditional operation. The skip can differ from a branch in that the skip operation, and the basic blocks executed or omitted by the skip operation, can all be executed within the slice. In contrast, a branch operation can conditionally transfer execution from a first basic block to a second basic block, where the first basic block and the second basic block are executing on different compute slices. In embodiments, the one or more skip instructions can include a forward branch within the first hyperblock. In the flow 100, the one or more skip instructions direct instruction execution 134 between the at least two basic blocks in the first hyperblock. That is, execution of the hyperblock can proceed from one basic block to another basic block within the hyperblock, while the hyperblock is executed on a single compute slice in the processor unit. Execution of one or more other basic blocks within the hyperblock can be skipped for a given iteration or altogether.

The flow 100 includes allocating a first slice task 140, by the control unit, to a first compute slice in the plurality of compute slices, wherein the first slice task comprises the first hyperblock that was created by the compiler. The allocating can be based on capabilities of the compute slices, availability of the compute slices, and so on. The allocating can be based on hyperblock priority, precedence, and the like. In embodiments, the first compute slice can include branch prediction logic. Since branches within the hyperblock were replaced with skip instructions, this can also be referred to as skip prediction logic. The skip prediction logic can make a prediction regarding which skip path associated with a conditional operation will likely be taken prior to the evaluation of the skip instruction. Based on the skip prediction, one or more instructions associated with a predicted skip path can be fetched and can be “pre-executed” ahead of the evaluation of the operands of the conditional operation. In embodiments, more than one skip path can be pre-executed. The correct path can then be chosen when the skip evaluation is determined. In embodiments, when a skip is mispredicted, the compute slice unrolls results from the point of the misprediction. If the skip was predicted correctly, the compute slice can continue with execution of the hyperblock.

In the flow 100, the allocating can include determining 142, by the control unit, an end of the first hyperblock, wherein the determining is based on the number of instructions within the first hyperblock. The end of the first hyperblock can be determined by counting instructions. In embodiments, the first hyperblock can include a first header, wherein the first header includes a number of instructions within the first hyperblock. The number of instructions included in the first header can be determined by the compiler at compile time. In other embodiments, an ending basic block in the hyperblock can indicate to the control unit that it has reached the end of the first hyperblock. The ending basic block can be added to the hyperblock by the compiler. Further embodiments include adding an instruction at the end of the ending basic block in the hyperblock. The instruction can indicate the end of the hyperblock. The control unit can use any of these methods to schedule hyperblocks on succeeding compute slices.

The flow 100 includes allotting a second slice task 150, by the control unit, to a second compute slice in the plurality of compute slices. The second slice task comprises at least one basic block within the plurality of basic blocks. In the flow 100, the allotting is based on branch prediction 152 logic within the control unit. The branch prediction logic can predict which branch path is likely to be taken when a branch decision is made and can allot the second slice code based on that prediction. In the flow 100, the second compute slice is coupled 160 to the first compute slice by a first barrier register set in the plurality of barrier register sets. The barrier register set can be used to communicate between the first compute slice and the second compute slice. In embodiments, the barrier register set enables unidirectional communication between compute slices. The first barrier register set can hold data generated by the first slice task, data required by the second slice task, etc. The first barrier register set can include one or more two-stage buffers. In a usage example, data can be loaded into the first barrier register set and can be available at the output of the first barrier register set for processing by the second slice task. Data can be generated by the first slice task as the first slice task is executed. The data generated by the first slice task can be loaded into, accumulated by, etc. an input stage of the first barrier register set. The data in the input stage of the first barrier set can be transferred to the output of the first barrier set based on a signal, a flag, and so on, such as a completion flag. The data can be transferred based on a decision such as a branch decision.

Discussed throughout, the allocating and the allotting can further be based on generating performance estimates for executing a hyperblock compared to executing the basic blocks associated with the hyperblock. Embodiments can include generating a first performance estimate, by the compiler, of executing the first hyperblock on the first compute slice. The first performance estimate can be based on computational resource utilization such as numbers of cycles, memory accesses, total time to completion, retiration interval, and so on. Embodiments can further include comparing the first performance estimate to a second performance estimate. The second performance estimate is based on executing the at least two basic blocks on the processing unit. The second performance estimate can include one or more dependencies passed between the at least two compute slices by at least one barrier register set in the plurality of barrier register sets. The performance estimate for the at least two basic blocks can be based on computational resource utilization, memory accesses, total time to completion, retiration interval, etc.

The flow 100 includes initializing pointers 170, wherein a head pointer points to the first compute slice, and wherein a tail pointer points to the second compute slice. The pointers can each point to a compute slice within the plurality of compute slices. A head pointer points to the first compute slice, and a tail pointer points to the second compute slice. The pointers can both point to the same compute slice when only one hyperblock is loaded into one compute slice, when execution of all hyperblocks has completed, when no compute slice blocks are loaded with slice tasks, and so on. The pointers can be updated. The head pointer can be updated when the compute slice to which it was pointing completes execution of the hyperblock loaded onto it. Further embodiments can include updating the tail pointer to point to the second compute slice. In a usage example, the head pointer and the tail pointer point to the same compute slice. A first slice task can be distributed to the compute slice pointed to by the head pointer. A second slice task can be allocated to the next available compute slice that can be coupled to the first compute slice by a first barrier register set.

The flow 100 includes executing the compiled program 180. In some embodiments, other slice tasks on other compute slices can begin executing based on speculative prediction of outcomes of conditional operations. The first compute slice can be pointed to by the head pointer. Thus, in the flow 100, the executing can begin at the first compute slice 182. Recall that the first hyperblock, including one or more skip instructions, was allocated to the first compute slice. Thus, the executing can begin with executing this first slice task. In embodiments, a first skip instruction within the one or more skip instructions includes a conditional operation. In the flow 100, the first hyperblock can be executed, by the first compute slice, without a prediction 184 of the conditional operation. That is, the first compute slice can wait until operands are available to evaluate a conditional operation associated with the skip instruction before proceeding with execution of the hyperblock. In other embodiments, the first compute slice can include executing all sides of a conditional operation, prior to the conditional operation being decided. When the conditional operation is decided, execution can continue on the determined path, while execution of other paths can be terminated and flushed.

The executing begins at the first compute slice. While one slice task is executed, other slice tasks may, in some cases, be executed in parallel. As previously discussed, the first compute slice can include branch prediction logic. Since branches within the hyperblock were replaced with skip instructions, this can also be referred to as skip prediction logic. The skip prediction logic can make a prediction regarding which skip path associated with a conditional operation will likely be taken prior to the evaluation of the skip instruction. Based on the skip prediction, one or more instructions associated with a predicted skip path can be fetched and can be “pre-executed” ahead of the evaluation of the operands of the conditional operation. In embodiments, more than one skip path can be pre-executed. The correct path can then be chosen when the skip evaluation is determined. In embodiments, when a skip is mispredicted, the compute slice unrolls results from the point of the misprediction. If the skip was predicted correctly, the compute slice can continue with execution of the hyperblock. Thus, in embodiments, the first compute slice includes a branch prediction hardware. In further embodiments, the first hyperblock is executed, by the first compute slice, with a prediction 186 of the conditional operation, wherein the prediction is based on the branch prediction hardware within the first compute slice. The branch prediction, or skip prediction, can be made based on examining the compiled code, runtime analysis of the code, and so on.

In the flow 100, the executing can include speculatively executing 188 the second compute slice. The speculative executing can be based on the branch prediction in the control unit. The control unit can assign multiple slice tasks to successor compute slices. These slice tasks can be speculatively executed in parallel. The speculative executing can include executing more than one path associated with a conditional operation.

The executing a code slice can generate data for an additional slice task. The executing a slice task can determine an actual branch decision as opposed to the predicted branch decision. Execution of slice tasks that depend on the outcome of the first slice task branch decision can continue execution when the branch prediction and the branch outcome are substantially similar. Other actions can be taken if the branch prediction and the branch outcome are substantially different. Embodiments can include ignoring a result from the second compute slice, wherein a branch instruction in the first compute slice was mispredicted by the branch prediction logic. Since the branch prediction for the first compute slice was incorrectly predicted by the branch prediction logic, then the slice task running on the second compute slice, which was based on the incorrectly predicted branch path of the first slice, becomes irrelevant. Further embodiments can include flushing, in the second compute slice, information stored in a write buffer. Further actions can be taken based on the branch misprediction. Embodiments can include updating the tail pointer to point to the first compute slice, wherein a next sequential slice task is not distributed to the second compute slice.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

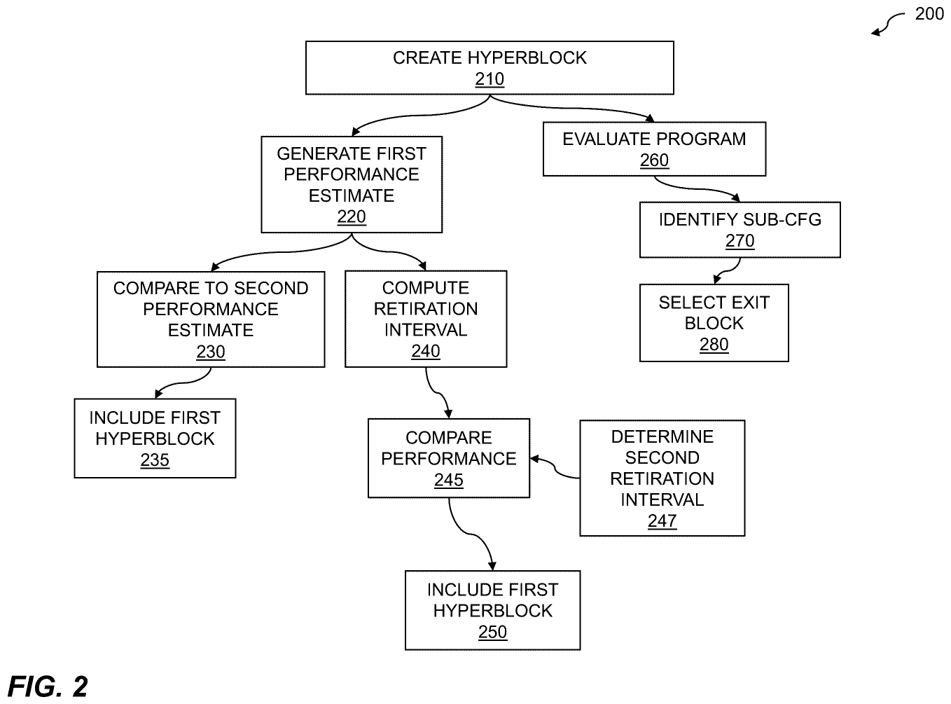

FIG. 2 is a flow diagram for creating hyperblocks in a parallel architecture with compute slices. One or more hyperblocks can be created by a compiler by evaluating a compiled program. Using the compiler to compile the program can generate basic blocks, where the basic blocks can be executed on compute slices associated with a processing unit. A hyperblock can be created by the compiler after the compiler evaluates the basic blocks based on a control flow graph (CFG). A hyperblock includes at least two basic blocks that were evaluated. The creating the hyperblock further includes replacing one or more branch instructions with one or more skip instructions. A skip instruction can enable skipping one or more portions of code such as a slice task associated with a code slice allocated to a compute slice. The skip instruction can enable continued execution of code on the compute slice without having to transfer execution to an additional compute slice. Compiling enables compiler generated hyperblocks in a parallel architecture with compute slices.

A processing unit comprising a plurality of compute slices, a plurality of barrier register sets, a control unit, and a memory system is accessed, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices. A compiled program is evaluated by the compiler, wherein the compiled program includes a plurality of basic blocks, wherein the evaluating is based on a control flow graph (CFG). A first hyperblock is created by the compiler, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock. The control unit allocates a first slice task to a first compute slice in the plurality of compute slices, wherein the first slice task comprises the first hyperblock that was created by the compiler. The control unit allots a second slice task to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. The compiled program is executed, wherein the executing begins at the first compute slice.

Two compute slices can be coupled to a barrier register set. The barrier register set can capture data generated by a compute slice, can hold data for processing by a compute slice, and so on. The barrier registers can enable data flow between an upstream (or predecessor) compute slice and a downstream (or successor) compute slice. The plurality of compute slices and the plurality of barrier register sets can be coupled in a ring configuration. The ring configurations can enable machine learning functionality to the array of compute elements. The machine learning can be based on supervised, unsupervised, and semi-supervised learning; deep learning (DL); and the like. In embodiments, the machine learning functionality can include a neural network implementation. The compute slices can be coupled to other elements within the processing unit. In embodiments, the coupling of the compute slices can enable one or more topologies. The other elements to which the compute slices can be coupled can include storage elements such as one or more levels of cache storage, multiplier units, address generator units for generating load (LD) and store (ST) addresses, queues, and so on. The compute slices can each be coupled to a load-store unit. The compiler can include C, C++, or another language. The processing unit can run code written in an interpreted language such as Python. The compiler can include a compiler written especially for the processing unit with which the compute slices are associated. The coupling of each compute slice to other elements within the processing unit enables sharing of elements such as cache elements, multicycle elements (multiplication, logarithm, square root, etc.), ALU elements, or a control unit; communications within the processing unit; and the like.

The flow 200 includes creating, by a compiler, a first hyperblock 210. The first hyperblock includes at least two basic blocks within a plurality of basic blocks. The basic blocks can be created by the compiler when the compiler compiles a program. Recall that the compiler can evaluate the compiled program that includes the basic blocks. The evaluating is based on a control flow graph (CFG). The CFG maps the paths that can be taken through a compiled program as the program is executed. The flow 200 includes generating a first performance estimate 220, by the compiler, of executing the first hyperblock on the first compute slice. The performance estimate can be based on computational resource utilization, numbers of processor cycles required to execute the hyperblock, elapsed time, retiration interval, and so on.

The performance estimate can be compared to one or more further performance estimates in order to minimize processor cycles, maximize throughput of the compute slice, optimize compute slice usage, etc. The flow 200 further includes comparing 230 the first performance estimate to a second performance estimate. The second performance estimate is based on executing the at least two basic blocks on the processing unit, wherein the executing includes at least two compute slices in the plurality of compute slices, and wherein one or more dependencies are passed between the at least two compute slices by at least one barrier register set in the plurality of barrier register sets. The executing on at least two compute slices may be able to enhance parallel program execution. In a usage example, branch paths associated with conditional instructions can be prefetched and pre-executed prior to evaluation of the conditional instruction. One or more dependencies are passed between the at least two compute slices by at least one barrier register set in the plurality of barrier register sets. The barrier register set can be used to communicate data between a first basic block executing on a first compute slice and a second basic block executing on a second compute slice. The communication of data can be unidirectional between the first compute slice and the second compute slice.

The first performance estimate and the second performance estimate can be compared. The flow 200 further comprises including, by the compiler, the first hyperblock in an object file 235, wherein the first performance estimate comprises fewer processing unit cycles than the second performance estimate. Discussed previously, the including the hyperblock can be based on choosing a preferred performance estimate. In embodiments, the first performance estimate can include fewer processing unit cycles than the second performance estimate. The object file can be converted to a load module and can be assigned by a control unit associated with the processing unit to a compute slice. In embodiments, the first hyperblock includes an external loop, wherein the external loop is based on a branch instruction within the first hyperblock, wherein the branch instruction within the first hyperblock branches to an entry block of the first hyperblock. The external loop can include a feed-forward loop, a feedback loop, and so on. The external loop can include a loop that is external to a sub-control flow graph (sub-CFG). In embodiments, the external loop can be based on a branch instruction within the first hyperblock. The branch instruction can include a conditional instruction. In embodiments, the branch instruction within the first hyperblock branches to an entry block of the first hyperblock. In a usage example, a loop can be based on a conditional operation associated with a do, for, or while loop. Any block of the hyperblock can provide the input to the input block (e.g., an external loop). Execution of the loop can continue until the condition is met and the loop exits.

In the flow 200, the generating includes computing 240 a retiration interval, wherein the retiration interval comprises a difference in total processor unit cycles required to complete successive iterations of the external loop in a steady state. The retiration interval can include a branch probability weighted mean of the cycles required to retire a single pass of the external loop. The branch probability weighted mean can include probabilities for each side of the external branch. The branch probability can also include probabilities for each side of one or more skip instructions within the external loop. In a usage example, the compiler can estimate that predicting a taken path of the external branch will result in completion of the loop in five cycles. The compiler can also estimate that predicting a non-taken path of the external branch will result in completion of the external loop in ten cycles. If the compiler also estimates that the probability of the taken path is 25% while the non-taken path is 75%, then the branch probability weighted mean of the external loop can be: (taken path cycles to complete) (25%)+(non-taken path cycles to complete) (75%)=(5 cycles) (0.25)+(10 cycles) (0.75)=9 cycles. Many possibilities of cycles and probabilities are possible. This process can be repeated for multiple iterations of the loop until a steady-state retiration interval is found.

The flow 200 further includes comparing the first performance estimate to a second performance estimate 245, wherein the second performance estimate is based on determining 247 a second retiration interval, wherein the second retiration interval comprises a difference in total processor unit cycles required to complete successive iterations of the external loop in a steady state, wherein the executing includes at least two compute slices in the plurality of compute slices, and wherein one or more dependencies are passed between the at least two compute slices by at least one barrier register set in the plurality of barrier register sets. The second retiration interval can be based on iterations of a loop associated with second performance estimate, where the second performance estimate is based on executing the at least two basic blocks on the processor unit without the use of a hyperblock. In this case, the branch prediction logic in the control unit can distribute basic blocks to any number of compute slices to represent iterations of the loop executing speculatively. The second performance estimate can also be based on a branch probability weighted mean as described above. In embodiments, the second retiration interval can include a difference in total processor unit cycles required to complete successive iterations of the external loop in a steady state. The steady number of processor unit cycles can be achieved after some number of iterations of the loop.

The flow 200 further comprises including, by the compiler, the first hyperblock in an object file 250, wherein the first performance estimate comprises fewer processing unit cycles than the second performance estimate. The first performance estimate and the second performance estimate are based on the first retiration estimate and the second retiration estimate, respectively. Though these performance estimates are based on the compiler and not on actual execution of the code, the process can optimize performance for various code types. When a performance advantage exists to use a hyperblock, the compiler can include the hyperblock in the object file. The object file can include both hyperblocks and separate basic blocks (also called “degenerate hyperblocks”) to optimize execution of specific code on the processor unit.

The flow 200 includes evaluating 260, by the compiler, a compiled program, wherein the compiled program includes a plurality of basic blocks. In embodiments, the evaluating includes identifying 270 a sub-CFG within the CFG, wherein the sub-CFG includes an entry basic block within the plurality of basic blocks, wherein the entry basic block comprises a single entry point to the sub-CFG, wherein the sub-CFG includes an exit basic block within the plurality of basic blocks, and wherein the exit basic block comprises a single exit point from the sub-CFG. The flow 200 includes selecting an exit block 280 from the sub-CFG. The evaluating is based on a control flow graph (CFG). Recall that a CFG can include a graphical representation of paths that can be taken through a program as the program is executed. In embodiments, the sub-CFG forms a directed acyclic graph (DAG). A DAG can include vertices or edges, where the vertices can be connected by edges or arcs. Each edge can direct flow from one vertex to one or more other vertices. The directions are unidirectional, thereby avoiding the forming of one or more closed loops. A loop can be formed outside of the sub-CFG (or DAG).

Some paths in the sub-CFG (or DAG) can be taken based on a conditional operation such as a branch instruction. The sub-CFG includes an entry basic block within the plurality of basic blocks. The entry block, or any other block within the sub-CFG, can receive communications from a block beyond the sub-CFG. The communications can be achieved by the aforementioned barrier registers. The entry basic block comprises a single entry point to the sub-CFG. In embodiments, every preceding basic block, within the CFG, to the entry basic block, is not included in the sub-CFG. That is, the sub-CFG can include a subset of the basic blocks within the CFG. Further blocks can be included in the sub-CFG. The sub-CFG includes an exit basic block within the plurality of basic blocks. The exit basic block can provide communications to a block beyond the sub-CFG. The exit basic block comprises a single exit point from the sub-CFG. In other embodiments, a preceding basic block, within the CFG, to the entry basic block, is the exit basic block. In this case, the coupling the output of the exit basic block to the input of the entry basic block can enable an external loop. In embodiments, the at least two basic blocks comprise the sub-CFG.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

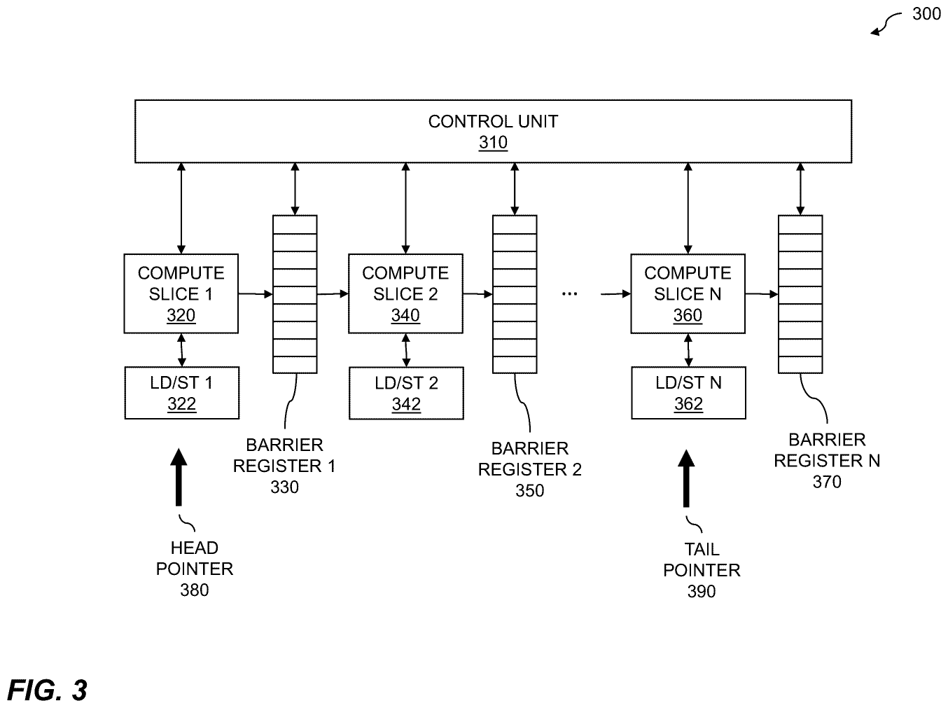

FIG. 3 is a block diagram for compute slice control. A processor unit can be used to process data for applications such as image processing, audio and speech processing, artificial intelligence and machine learning, and so on. The processor unit includes a variety of elements, where the elements include compute slices, barrier register sets, a control unit, a memory system, busing and networking, and so on. The compute slices can obtain data for processing. The data can be obtained from the memory system, cache memory, a scratchpad memory, and the like. Compute slices can be coupled together using a barrier register set, where a first compute slice can only write to the barrier register and a second compute slice can only read from the barrier register. The control unit can control data access, data processing, etc. performed by the compute slices. Compute slice control enables compiler-generated hyperblocks in a parallel architecture with compute slices.

A processing unit comprising a plurality of compute slices, a plurality of barrier register sets, a control unit, and a memory system is accessed, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices. A compiled program is evaluated by the compiler, wherein the compiled program includes a plurality of basic blocks, wherein the evaluating is based on a control flow graph (CFG). A first hyperblock is created by the compiler, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock. The control unit allocates a first slice task to a first compute slice in the plurality of compute slices, wherein the first slice task comprises the first hyperblock that was created by the compiler. The control unit allots a second slice task to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. The compiled program is executed, wherein the executing begins at the first compute slice.

Compiled programs that are based on slice tasks can be executed on a parallel processing architecture such as the accessed processing unit. Some slice tasks associated with the program, for example, can be executed in parallel, while others must be properly sequenced. The sequential execution and the parallel execution of the tasks are dictated in part by the existence of or absence of data dependencies between tasks. In a usage example, compute slice A, running slice task A, processes input data and produces output data that is required by compute slice B, running slice task B. Thus, for correct results, slice task A must first generate the input required by slice task B before slice task B can execute on compute slice B. In this case, compute slice B can stall while waiting for results from the predecessor slice. Once the results are obtained, compute slice B can execute slice task B speculatively while slice task A proceeds. Compute slice C, however, holds slice task C that executes instructions that process the same input data as slice task A and produces its own output data. Thus, slice task C can be speculatively executed in parallel with slice tasks A and B. The execution of tasks can be based on memory access operations, where the memory access operations include data loads from memory, data stores to memory, and so on. The execution of tasks can further be based on data loads to a barrier register set and data stores to a barrier register set. If, in the example just recited, slice task B were to attempt to access and process data prior to slice task A producing the data required by slice task B, a hazard would occur. Thus, hazard detection and mitigation can be critical to successful parallel processing. In embodiments, the hazards can include write-after-read, read-after-write, and write-after-write conflicts. The hazard detection can be based on identifying memory access operations that access the same address. The hazard detection can include checking between store buffers and load address buffers within a load-store unit coupled to each compute slice.

Data can be moved between a memory such as a memory system, a memory data cache, etc. and storage elements associated with the processing unit. The storage elements associated with the processing unit can include scratchpad memory, register files, and so on. The storage elements associated with the processing unit can include barrier register sets. Memory access operations can include loads from memory, stores to memory, memory-to-memory transfers, etc. The storage elements can include a local storage coupled to one or more compute slices, storage associated with the processing unit, cache storage, a memory system, and so on.

A block diagram 300 for compute slice control is shown. Compute slice control can include hazard detection and mitigation. The hazard mitigation can be based on distributing and allotting slice tasks to compute slices. One or more hazards, which can be encountered during memory access operations, can result when two or more memory access operations attempt to access the same memory address. While multiple loads (reads) from an address may not create a hazard, combinations of loads and stores to the same address can be problematic. Hazard detection and mitigation techniques enable memory access operations to be performed while avoiding hazards. The memory access operations, which can be performed using load-store units associated with each compute slice, can include loading data from memory and storing data to memory. The data is loaded from memory to supply data slice tasks executing on compute slices. The data can be required or generated by slice tasks associated with programs to be executed on a processing unit. Data produced by the slice tasks can be stored back to the memory.

The processing unit can include a control unit 310. The control unit can be used to control one or more compute slices, barrier registers, and so on associated with the processing unit. The control unit can operate based on receiving a set of slice tasks from a compiler. The compiler can include a high-level computer, a hardware language compiler, a compiler developed for use with the processing unit, and so on. The control unit can distribute and allocate slice tasks to compute slices associated with the processing unit. The control unit can be used to commit a result of a slice task to a barrier register when execution of the slice task has been completed. The control unit can perform checking operations. The checking operations can check that a slice task is a next sequential slice task in a compiled program. The checking can be based on execution of a first compute slice. The control unit can perform assigning operations. The assigning operations can include assigning the next sequential slice task in the compiled program to a second compute slice, assigning a third slice task to a third compute slice, and so on. The control unit can perform state assignment operations. Embodiments can include assigning, by the control unit, a state to each compute slice in the plurality of compute slices, wherein the state is one of idle, executing, holding, or done. The assigned states can be used to determine whether a compute slice is ready to receive a slice task, data is ready to be committed, etc. The state of a compute slice can be used for exception handling techniques. The exception handling techniques can be associated with nonrecoverable exceptions and recoverable exceptions.

The processing unit can include a plurality of compute units. The compute units can be issued, by the control unit, to slice tasks for execution. The slice tasks can include blocks of code associated with a compiled program generated by the compiler. In the figure, the compute slices include compute slice 1 320, compute slice 2 340, and compute slice N 360. The number of compute slices that can be included in the processing unit can be based on a processing architecture, a number of processor cores on an integrated circuit or chip, and the like. A load-store unit can be associated with each compute slice. The load-store unit can be used to provide load data obtained from a memory system for processing on the associated code slice. The load-store unit can be used to hold store data generated by the compute slice and designated for storing in the memory system. The load-store unit can include load-store unit 1 322 associated with compute slice 1 320, load-store unit 2 342 associated with compute slice 2 340, and load-store unit N 362 associated with compute slice N 360. As the number of compute slices changes for a particular processing unit architecture, the number of load-store units can change correspondingly.

The processing unit can include a plurality of sets of barrier registers. The barrier registers can be used to hold load data to be processed by a compute slice, to receive store data generated by a compute slice, and so on. In embodiments, a second compute slice can be coupled to a first compute slice by a first barrier register set in the plurality of barrier register sets. In the block diagram, barrier register 1 330 can couple compute slice 2 340 to compute slice 1 320, barrier register 2 350 can couple compute slice 3 (not shown) to compute slice 2 340, barrier register N 370 can couple compute slice N+1 (not shown) to compute slice N 360, etc. Since slice tasks can be issued to compute slices in an order such as from left to right, a left-hand compute slice or predecessor compute slice only has to write to a barrier register coupled to a right-hand compute slice or successor. That is, a successor compute slice does not have to write to a processor compute slice, nor does a predecessor compute slice have to read from a successor compute slice. In embodiments, the predecessor compute slice can be to the left of the successor compute slice. In further embodiments, the plurality of compute slices and the plurality of barrier register sets can be coupled in a ring configuration. Thus, barrier register N 370 can be coupled between compute slice N 360 and compute slice 1 320.

Pointers can be used to indicate which compute slice has been allocated the first slice task, which compute slice has been allotted the second slice task, and so on. In embodiments, pointers are initialized. The initializing the pointers can include pointing to a first compute slice, pointing to a second compute slice, pointing to the last compute slice to which a slice task has been allotted, and so on. In embodiments, a head pointer 380 points to the first compute slice, and a tail pointer 390 points to the second compute slice. The pointers can point to two different compute slices, to the same compute slice, etc. In a usage example, a program comprises one hyperblock, and the one hyperblock has been assigned to compute slice 1. The head pointer and the tail pointer point to the same compute slice, compute slice 1, because that is the only compute slice to which a slice task, here the one hyperblock, has been assigned. In another example, a basic block and hyperblocks have been completed. Here, the head pointer and the tail pointer can point to an unassigned compute slice to indicate that no processing is necessary at a given time.

Data movement, whether loading, storing, transferring, etc., can be accomplished using a variety of techniques. In embodiments, memory system access operations can be performed outside of processing unit, thereby freeing the compute slices with the processing unit to execute slice tasks. Memory access operations, such as autonomous memory operations, can preload data needed by one or more compute slices. The preloaded data can be placed in buffers associated with compute slices that require the data. In additional embodiments, a semi-autonomous memory copy technique can be used for transferring data. The semi-autonomous memory copy technique can be accomplished by the processing unit which generates source and target addresses required for the one or more data moves. The processing unit can further generate a data size such as 8, 16, 32, or 64-bit data sizes, and a striding value. The striding value can be used to avoid overloading a column of storage components such as a cache memory.

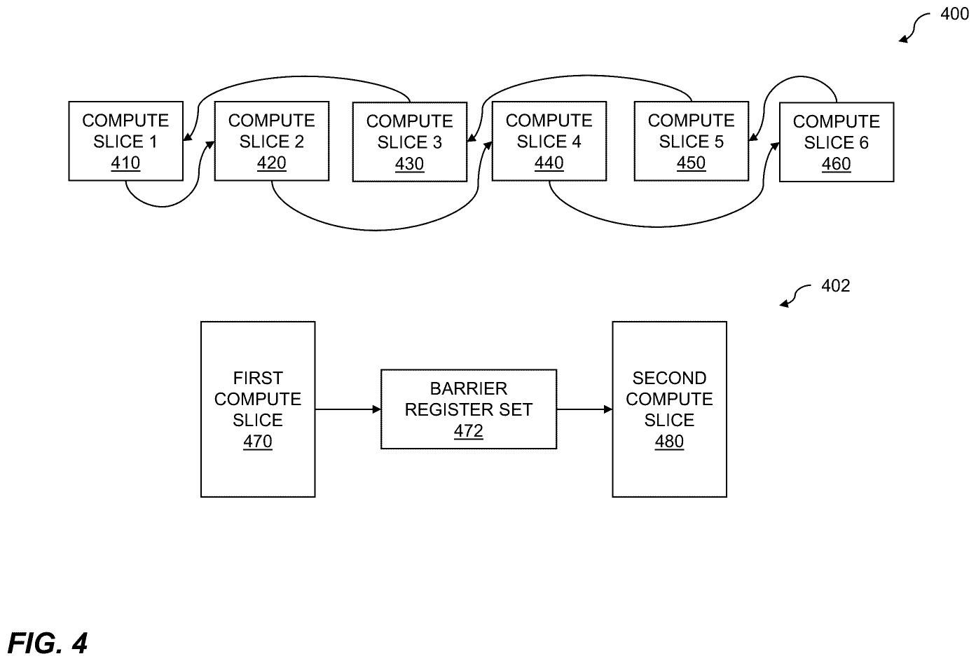

FIG. 4 illustrates a system block diagram for a ring configuration of compute slices. Described previously and throughout, a processing unit can be used to process a compiled program. The program can be associated with processing applications such as image processing, audio processing, and natural language processing applications. The processing can be associated with artificial intelligence applications such as machine learning. The processing unit can include various elements. Among other elements, the processing unit can comprise compute slices that are coupled to barrier register sets. A barrier register set can be coupled between two compute slices to enable unidirectional communication between the two compute slices. The barrier register set can be used to hold data for processing by a compute slice, can receive committed effects such as data and branch decisions from the compute slices, and so on. Pointers such as a head pointer and a tail pointer can be used to direct blocks of code issued by a control unit to the compute slices for execution. The compute slices and the barrier register sets can be coupled in a ring configuration. The ring configuration of the compute slices and the barrier register sets enable compiler-generated hyperblocks in a parallel architecture with compute slices. A processing unit comprising a plurality of compute slices, a plurality of barrier register sets, a control unit, and a memory system is accessed, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices. A compiled program is evaluated by the compiler, wherein the compiled program includes a plurality of basic blocks, wherein the evaluating is based on a control flow graph (CFG). A first hyperblock is created by the compiler, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock. The control unit allocates a first slice task to a first compute slice in the plurality of compute slices, wherein the first slice task comprises the first hyperblock that was created by the compiler. The control unit allots a second slice task to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. The compiled program is executed, wherein the executing begins at the first compute slice. The first slice can be pointed to by the head pointer.

A ring configuration of compute slices is shown 400. The compute slices within the ring configuration can include compute slice 1 410, compute slice 2 420, compute slice 3 430, compute slice 4 440, compute slice 5 450, compute slice 6 460, and so on. While six compute slices are shown, the ring of compute slices can also comprise more or fewer compute slices. The ring configuration can be accomplished using an integrated circuit or chip, a plurality of compute slice cores, a configurable chip, and the like. The ring configuration can be based on a regularized circuit layout, equalized interconnect lengths, and so on. A compute slice can be coupled to a second slice 402. A first compute slice 470 can be coupled to a second compute slice 480 using a barrier register set 472. The barrier register set can include a register set within a plurality of barrier register sets. Each compute slice of 400 and 402 can be coupled to a load-store unit (not shown). The load-store unit can handle data and instruction transfers between the compute slices and a memory system. Further, each compute slice can be coupled to a control unit (not shown). The control unit can enable loading and execution of slice tasks, loading and storing data in barrier registers, etc.

Discussed previously, each compute slice can independently execute a block of code called a slice task. The slice tasks that can be associated with the compute slices can be associated with a compiled program. The execution of the slice tasks can be controlled by a local program counter associated with each compute slice. Communication between a slice and its immediate neighbors, such as a predecessor compute slice and a successor compute slice, is accomplished using a barrier register set. Recall that a control unit that can control the compute slices can ensure that the slice task order is issued in one direction such as from left to right. As a result, a compute slice is not required to write to a predecessor compute slice, nor to read from a successor compute slice. In a usage example, the first compute slice can only write to the barrier register and that the second compute slice can only read from the barrier register. This architectural technique can ensure that a compute slice that requires input data from a predecessor compute slice can read valid data. That is, the first compute slice generates data, branch decisions, etc., and writes this information to the input of the barrier register while the output of the register remains unchanged. The data being read at the output of the barrier register will remain valid while the second compute slice is processing data. The results from the first compute slice are not committed until after the first compute slice has completed execution and the second compute slice has obtained its data. The committing is performed by the control unit. This technique eliminates a race condition such as a write-before-read race condition.

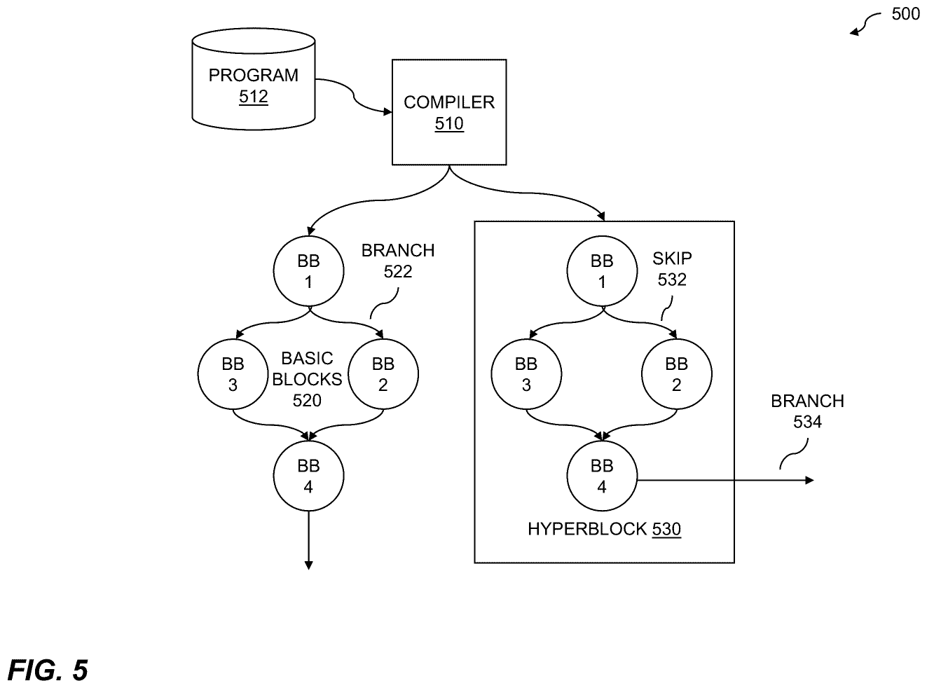

FIG. 5 is an example of a compiler generating a hyperblock with skip instructions. A compiler can be used to compile code such as application code for a processor unit. Recall that each compute slice within the processor unit is known to the compiler and can therefore be used to execute one or more portions of the compiled code. The compiler can also be used to identify precedence and priorities within portions of the code such as portions of the code that can be executed in parallel, portions that must be executed in series, and so on. The compiler can further be used to generate performance estimates for the compiled code. The compiler enables compiler-generated hyperblocks in a parallel architecture with compute slices. A processing unit comprising a plurality of compute slices, a plurality of barrier register sets, a control unit, and a memory system is accessed, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices. A compiled program is evaluated by the compiler, wherein the compiled program includes a plurality of basic blocks, wherein the evaluating is based on a control flow graph (CFG). A first hyperblock is created by the compiler, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock. The control unit allocates a first slice task to a first compute slice in the plurality of compute slices, wherein the first slice task comprises the first hyperblock that was created by the compiler. The control unit allots a second slice task to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. The compiled program is executed, wherein the executing begins at the first compute slice.

The example 500 shows a compiler being used to compile code. The compiler 510 obtains a program 512. The compiler compiles code written in a software language. The compiler can compile code written in C, C++, or another language. The compiler can include a compiler written especially for the processing unit. The processing unit can run code written in an interpreted language such as Python. The compiler compiles the program. The compiling of the program can generate one or more basic blocks 520. In the figure, four basic blocks are shown, including basic block BB 1, basic block BB 2, basic block BB 3, and basic block BB 4. While four basic blocks are shown, the compiler can generate one or more basic blocks. The compiler can further be used to evaluate the compiled program. The basic blocks show the flow of data and control among the basic blocks. The basic block BB I can include a branch instruction 522. A branch prediction can be made using branch prediction logic within a control unit associated with the processing unit.

The compiled program, which includes a plurality of basic blocks, can be evaluated by the compiler. The evaluating by the compiler is based on a control flow graph (CFG). The control flow graph shows all of the paths that can be taken or traversed while the program is being executed. In the CFG, each node of the graph represents a basic block. Directed arcs or edges in the CFG show transfer of control within the code. The directed edges represent jumps within the code from one basic block to another basic block. The compiler can create a hyperblock such as hyperblock 530. The hyperblock can include at least two basic blocks. In embodiments, the hyperblock can comprise a single basic block (called a “degenerate hyperblock”). The creating of the hyperblock replaces one or more branch instructions with one or more skip instructions. The skip instruction can selectively skip a basic block within a hyperblock based on a conditional operation. The skip can differ from a branch in that the skip operation, and the basic blocks executed or omitted by the skip operation, are all executed within the hyperblock. In contrast, a branch operation can conditionally transfer execution from a first basic block to a second basic block, where the first basic block and the second basic block are executing on different compute slices. The one or more skip instructions direct instruction execution between the at least two basic blocks in the first hyperblock, which can execute on a single compute slice. In embodiments, the compute slice includes branch prediction logic (also called skip prediction logic). In this case, the skip instruction can be executed with a prediction. If it is later determined that the skip prediction was incorrect, results from the compute slice can be rolled back or discarded. In other embodiments, the compute slice does not include branch (or skip) prediction logic. In this case, the skip instruction is executed when the operands for the conditional operation are available and thus no prediction is necessary. An example skip instruction 532 is shown. A skip instruction can be internal to a hyperblock. The skip can be used to jump between basic blocks. The skip instruction can be used to link the basic blocks into the hyperblock. The skip can enable forward progress of executing basic blocks within the hyperblock when the set of basic blocks in the hyperblock forms a directed acyclic graph (DAG). That is, the arcs or edges in the graph only direct forward and do not loop back within the hyperblock. The exit from a hyperblock can include a branch 534. The branch, which can be based on a decision operation, can be taken to a further hyperblock, a basic block, and the like.

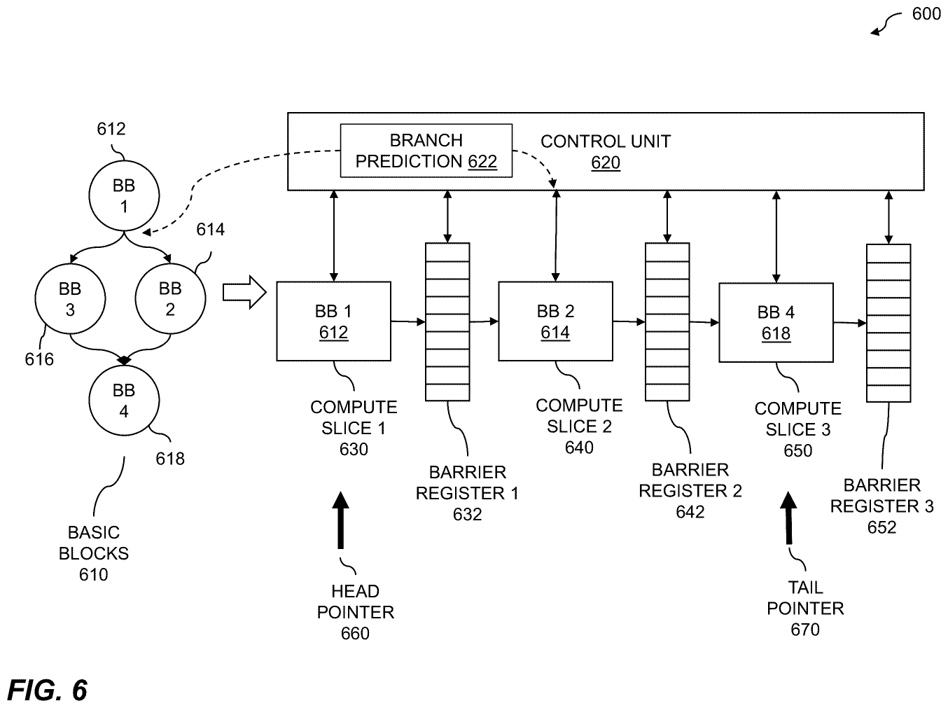

FIG. 6 is an execution example of separate basic blocks on a parallel architecture with compute slices. Discussed previously, performance estimates can be generated by a compiler to compare execution performance of a hyperblock to execution performance of constituent basic blocks associated with the hyperblock. The performance estimates can be compared to determine if executing the hyperblock or executing the two or more constituent basic blocks is computationally more efficient. When executing the basic blocks, the basic blocks can be allocated and allotted to compute slices. The allocation and the allotment of basic block slices enables a parallel architecture with compute slices. A processing unit comprising a plurality of compute slices, a plurality of barrier register sets, a control unit, and a memory system is accessed, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices. A compiled program is evaluated by the compiler, wherein the compiled program includes a plurality of basic blocks, wherein the evaluating is based on a control flow graph (CFG). A first hyperblock is created by the compiler, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock. The control unit allocates a first slice task to a first compute slice in the plurality of compute slices, wherein the first slice task comprises the first hyperblock that was created by the compiler. The control unit allots a second slice task to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. The compiled program is executed, wherein the executing begins at the first compute slice.

The execution example 600 shows basic blocks that can be associated with a control flow graph (CFG), which can be allocated to compute slices within a processing unit. The basic blocks can then be executed. A simple graph based on basic blocks is shown 610. The graph includes four basic blocks, basic block BB 1 612, basic block BB 2 614, basic block BB 3 616, and basic block BB 4 618. The basic blocks can be allocated and allotted to compute slices within the processing unit. The allocating and the allotting of the basic blocks to the compute slices can be accomplished by a control unit 620. The control unit can assign basic blocks, provide data, generate and provide control signals, handle interrupts, and so on. The assignment of the basic blocks to compute slices can be based on a conditional operation such as a branch operation. Block BB 1 612 includes a conditional operation that includes two possible paths, where one path proceeds to block BB 2 614, and the other path proceeds to block BB 3 616. Execution of the graph can be enhanced by predicting which branch path will be taken by the conditional operation associated with block BB 1 612. The control unit can include a branch prediction element 622. The branch prediction logic can predict that the block BB 2 614 can be executed after block BB 1 612. Block BB 4 618 can be executed after block BB 2 614. Thus, based on the determination by the branch prediction logic, basic blocks BB 1 612, BB 2 614, and BB 4 616 can be respectively assigned by the control unit to compute slice 1 630, compute slice 2 640, and compute slice 3 650.

Discussed previously, a processing unit comprises a plurality of compute slices, a plurality of barrier register sets, and a control unit. The processing unit further includes a memory system (not shown). In the figure, the processing unit can include compute slice 1 630, compute slice 2 640, and compute slice 3 650. A compute slice can be coupled to a successor compute slice and a predecessor compute slice by a barrier register set in the plurality of barrier register sets. In the figure, compute slice 1 is coupled to compute slice 2 by barrier register 1 632, and compute slice 2 is coupled to compute slice 3 by barrier register 2 642. Compute slice 3 is coupled to a further barrier register, barrier register 3 652. The control unit can allocate and allot basic blocks as compute tasks to compute slices. In the figure, basic block 1 is allocated to compute slice 1; basic block 2 is allotted to compute slice 2, and basic block 4 is allotted to compute slice 3. When data to be processed by the compute slices is available, and when associated control signals are presented, the basic blocks can be executed on the processing unit.

Pointers can be used to control execution of basic blocks on compute slices. The pointers can be initialized by logic such as logic associated with the control unit. In embodiments, the pointers are initialized, wherein a head pointer 660 points to the first compute slice, and wherein a tail pointer 670 points to the second compute slice. The pointers can be updated as execution of the basic blocks proceeds. The pointers can be used to identify which compute slice was provided in the first slice task. The tail pointer can identify which compute slice was allotted a second slice task, the last predicted compute slice. The head pointer and the tail pointer can be updated independently as discussed below. The tail pointer, for example, can be updated based on issuing further slice tasks, completion of execution of slice tasks, and the like. The head pointer and the tail pointer can be updated based on slice task execution status, branch operation outcome determination, and so on.

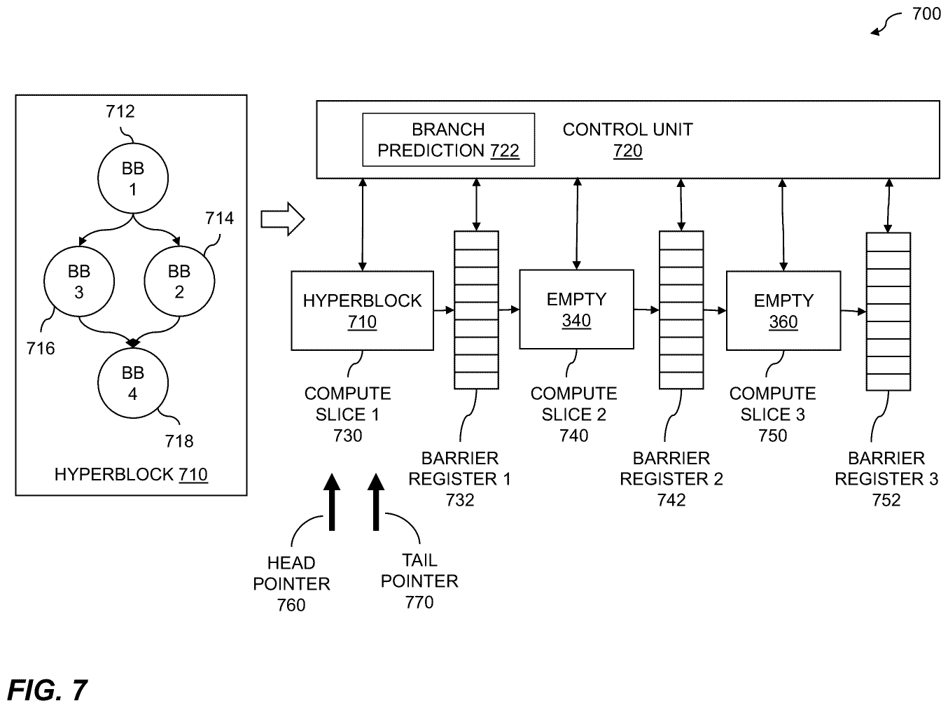

FIG. 7 is an execution example of a hyperblock on a parallel architecture with compute slices. A compiled program is evaluated by a compiler, where the evaluating is based on a control flow graph (CFG). The hyperblock is created by the compiler, where the hyperblock includes at least two basic blocks within the plurality of basic blocks that were evaluated. The creating of the hyperblock includes replacing one or more branch instructions with one or more skip instructions. The one or more skip instructions direct instruction execution between the at least two basic blocks in the first hyperblock. Discussed previously, performance estimates generated by a compiler can compare execution performance of the hyperblock to execution performance of constituent basic blocks (discussed previously) associated with the hyperblock. The performance estimates can be compared to determine whether executing the hyperblock or executing the two or more constituent basic blocks is computationally more efficient. When executing the hyperblock, the hyperblock can be allocated to a single compute slice. Thus, execution does not need to transfer to a further compute slice based on execution of a conditional operation. Instead, execution can continue on the single compute slice to which the hyperblock was allocated. The allocation of hyperblock to a compute slice enables compiler generated hyperblocks in a parallel architecture with compute slices.

A hyperblock can be executed on a processing unit, where the processing unit comprises a parallel architecture with compute slices. A compiled program that includes a plurality of basic blocks can be evaluated by the compiler. Recall that the evaluating is based on a control flow graph (CFG). The evaluating can identify conditional operations such as branches, can predict conditional operation outcomes, and so on. The hyperblock is created by the compiler. The hyperblock includes at least two basic blocks within the blocks there were evaluated. The creating replaces one or more branch instructions with skip instructions. A skip instruction directs instruction execution between the at least two basic blocks within the hyperblock. That is, execution does not need to transfer to a basic block on an additional compute slice. Instead, execution continues on the first compute slice.

In the execution example 700, a hyperblock 710 that includes a plurality of basic blocks is shown. The hyperblock includes four basic blocks, basic block BB 1 712, basic block BB 2 714, basic block BB 3 716, and basic block BB 4 718. The hyperblock can be allocated to a compute slice within the processing unit. The allocating of the hyperblock to a compute slice can be accomplished by a control unit 720. The control unit can assign a hyperblock, provide data to the hyperblock, generate and provide control signals, handle interrupts, and so on. The assignment of the hyperblock to compute slice can be based on replacing a conditional operation such as a branch operation with a skip operation. The skip operation directs instruction execution between at least two basic blocks within the hyperblock. Block BB 1 712 includes a conditional operation that includes two possible paths, where one path proceeds to block BB 2 714, and the other path proceeds to block BB 3 716. In the execution example 600, the branch prediction logic 722 determined a likely path of execution and allocated and allotted basic blocks to compute slices. In the execution example 700, the branch prediction in the control unit is not used. Instead, the hyperblock 710 can be assigned by the control unit 720 to a compute slice within the processing unit. In the execution example 700, the execution path of the hyperblock containing BB 1 712, BB 2 714, BB 3 716, and BB 4 718 can be determined by real time execution of operands in compute slice 1 730.

The processing unit comprises a plurality of compute slices, a plurality of barrier register sets, and a control unit. The processing unit further includes a memory system (not shown). In the figure, the processing unit can include compute slice 1 730, compute slice 2 740, and compute slice 3 750. A compute slice can be coupled to a successor compute slice and a predecessor compute slice by a barrier register set in the plurality of barrier register sets. In the figure, compute slice 1 is coupled to compute slice 2 by barrier register 1 732, and compute slice 2 is coupled to compute slice 3 by barrier register 2 742. Compute slice 3 is coupled to a further barrier register, barrier register 3 752. The control unit can allocate hyperblocks as compute tasks to compute slices. In the figure, the hyperblock is allocated to compute slice 1. When data to be processed by the compute slices is available, and when associated control signals are presented, the hyperblock can be executed on compute slice 1 within the processing unit.

Pointers are used to control execution of a hyperblock on a compute slice. The pointers can be initialized by logic such as logic associated with the control unit. In embodiments, the pointers are initialized, wherein a head pointer 760 points to the first compute slice, and wherein a tail pointer 770 also points to the first compute slice. In this example, there is no additional hyperblock allotted to a compute slice. The pointers can be updated as execution of the hyperblock proceeds. The head pointer and the tail pointer can be updated independently as discussed below. The tail pointer, for example, can be updated based on issuing further slice tasks, completion of execution of slice tasks, and the like.

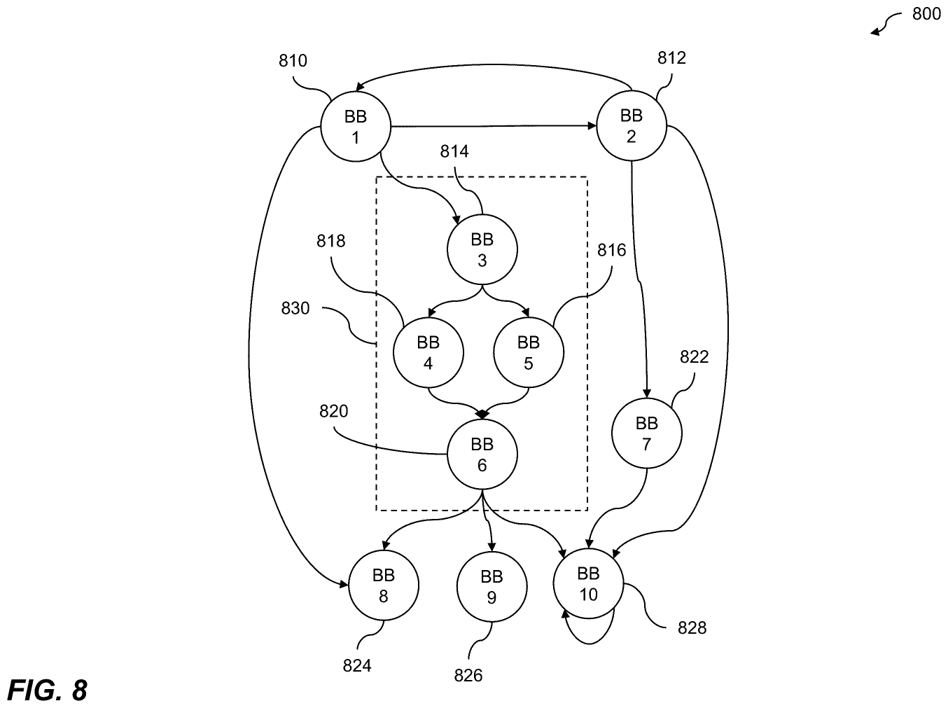

FIG. 8 is an example of identifying a sub-CFG. Evaluation by a compiler of a compiled program that includes a plurality of basic blocks can be based on a control flow graph (CFG). A control flow graph represents all execution paths that can be traversed through a program. The CFG can be large and complex. The evaluation can further identify a smaller sub-CFG within the CFG. The sub-CFG can form a directed acyclic graph (DAG), where a directed graph progresses in a “forward” direction. Here, a forward direction can include progressing through the graph from node to node, looping back to a previous node. The sub-CFG can be assigned to a compute slice for execution. Sub-CFGs enable compiler-generated hyperblocks in a parallel architecture with compute slices.

A processing unit comprising a plurality of compute slices, a plurality of barrier register sets, a control unit, and a memory system is accessed, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices. A compiled program is evaluated by the compiler, wherein the compiled program includes a plurality of basic blocks, wherein the evaluating is based on a control flow graph (CFG). A first hyperblock is created by the compiler, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock. The control unit allocates a first slice task to a first compute slice in the plurality of compute slices, wherein the first slice task comprises the first hyperblock that was created by the compiler. The control unit allots a second slice task to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. The compiled program is executed, wherein the executing begins at the first compute slice.

The example 800 shows a sub-control flow graph (sub-CFG) within a control flow graph (CFG). The CFG comprises a plurality of basic blocks. In the example, the basic blocks include basic block 1 BB 1 810, basic block 2 BB 2 812, basic block 3 BB 3 814, basic block 5 BB 5 816, basic block 4 BB 4 818, basic block 6 BB 6 820, basic block 7 BB 7 822, basic block 8 BB 8 824, basic block 9 BB 9 826, and basic block 10 BB 10 828. The CFG can include feed-forward loops such as an arc or edge from BB 1 to BB 2, and an edge returning from BB 2 to BB 1. The CFG can include a node which can loop back onto itself such as BB 10. In embodiments, the evaluating includes identifying a sub-CFG within the CFG. In the example shown, the sub-CFG that can be identified can include basic blocks BB 3, BB 4, BB 5, and BB 6, as indicated by dashed line box 830. The sub-CFG includes an entry basic block within the plurality of basic blocks. The entry into the sub-CFG is to basic block BB 3. In embodiments, the entry basic block comprises a single entry point to the sub-CFG. The sub-CFG includes an exit basic block within the plurality of basic blocks. The exit from the sub-CFG is from basic block BB 6. In embodiments, the exit basic block comprises a single exit point from the sub-CFG.

In embodiments, the sub-CFG forms a directed acyclic graph (DAG). The DAG proceeds from the entry basic block BB 3, through either basic block BB 5 or basic block BB 4, to exit basic block BB 6. In embodiments, the at least two basic blocks of a CFG can form the sub-CFG. The sub-CFG can include two or more basic blocks. There are no loops or backflow edges within the sub-CFG. In embodiments, every preceding basic block, within the CFG, to the entry basic block, is not included in the sub-CFG. In the figure, a preceding block can include basic block BB 1. BB 1 is outside the sub-CFG because BB 1 can form a feedback loop with BB 2, can bypass the sub-CFG to basic block BB 8, and so on. For some programs, a loop is required while executing the compiled program. In other embodiments, a preceding basic block, within the CFG, to the entry basic block, is the exit basic block. That is, the exit block is a successor to the entry block through at least one directed edge of the CFG, a sub-CFG, etc. In a usage example, a loop can be set up outside of the sub-CFG by coupling the output of the exit basic block to the input of the entry basic block. Such a configuration can enable looping in program execution while maintaining the sub-CFG. Further embodiments can include selecting the exit basic block, wherein the exit basic block is based on a nearest common post-dominator of one or more successor basic blocks of the entry basic block, wherein the one or more successor basic blocks are within the sub-CFG.

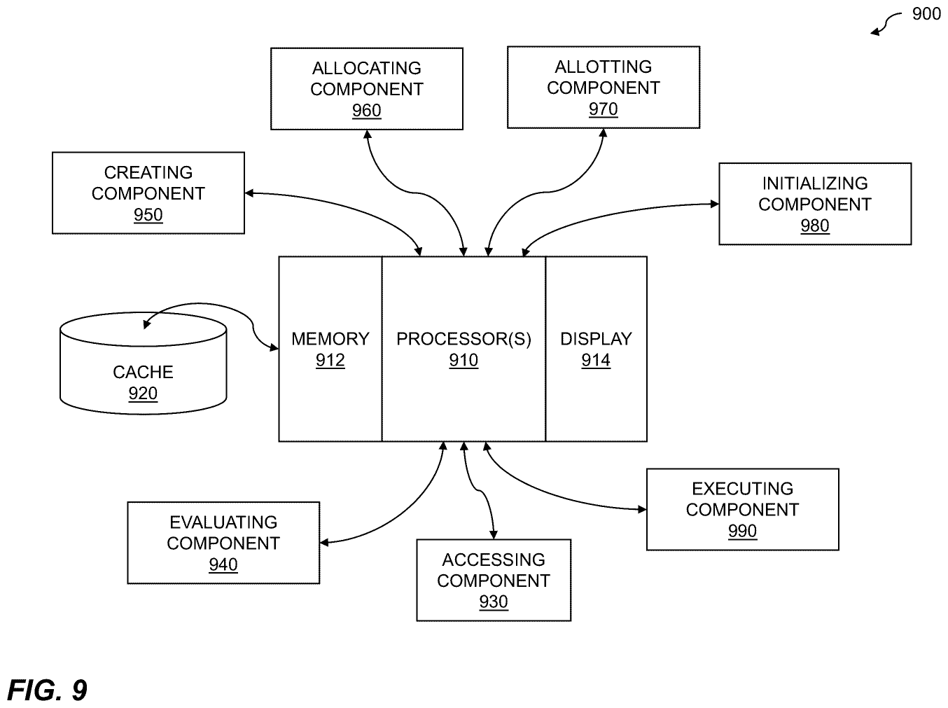

FIG. 9 is a system diagram for computer processing. The computer processing is enabled by compiler generated hyperblocks in a parallel architecture with compute slices. The system 900 can include one or more processors 910, which are coupled to a memory 912 which stores instructions. The system 900 can further include a display 914 coupled to the one or more processors 910 for displaying data; intermediate steps; task slices; basic blocks, hyperblocks, topologies including systolic, vector, cyclic, spatial, streaming, or VLIW topologies; and so on. In embodiments, one or more processors 910 are coupled to the memory 912, wherein the one or more processors, when executing the instructions which are stored, are configured to: access a processing unit comprising a plurality of compute slices, a plurality of barrier register sets, a control unit, and a memory system, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices; evaluate, by the compiler, a compiled program, wherein the compiled program includes a plurality of basic blocks, wherein the evaluating is based on a control flow graph (CFG); create, by the compiler, a first hyperblock, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock; allocate a first slice task, by the control unit, to a first compute slice in the plurality of compute slices, wherein the first slice task comprises the first hyperblock that was created by the compiler; allot a second slice task, by the control unit, to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets; initialize pointers, wherein a head pointer points to the first compute slice, and wherein a tail pointer points to the second compute slice; and execute the compiled program, wherein the executing begins at the first compute slice.

The system 900 can include a cache 920. The cache 920 can be used to store data such as scratchpad data and intermediate results; compiled basic blocks and hyperblocks; slice tasks for compute slices; hyperblock performance estimates, two or more basic block performance estimates, and process cycle comparisons; operations that support a balanced number of execution cycles for a data-dependent branch; microcode; branch predictions and decisions; and so on. The cache can comprise a small, local, easily accessible memory available to one or more compute slices within one or more processing units. In embodiments, the data that is stored can include operations, data, and so on.

The system 900 can include an accessing component 930. The accessing component 930 can include control logic and functions for accessing a processing unit. The processing unit can be accessible within an integrated circuit, an application-specific integrated circuit (ASIC), a programmable unit such as a field-programmable gate array (FPGA), and so on. The processing unit can comprise a plurality of compute slices, a plurality of barrier register sets, a control unit, and a memory system. Each processing unit is known to a compiler. Each compute slice within the plurality of compute slices includes at least one execution unit. A compute slice can include one or more processors, processor cores, processor macros, processor cells, and so on. Each compute slice can include an amount of local storage. The local storage may be accessible by one or more compute slices. The compute slices can be organized in a ring. Compute slices within the ring can be accessed using pointers. The pointers can include a head pointer, a tail pointer, and the like. Each compute slice is coupled to a successor compute slice and a predecessor compute slice by a barrier register set in the plurality of barrier register sets. The barrier register set provides for communication of data between successive compute slices. Communication between and among compute slices can be accomplished using a bus such as an industry standard bus, a ring bus, a network such as a wired or wireless computer network, etc. In embodiments, the ring bus is implemented as a distributed multiplexor (MUX).

The system 900 can include an evaluating component 940. The evaluating component 940 can include control and functions for evaluating, by the compiler, a compiled program. The compiler can include C, C++, or another language. The compiler can include a compiler written especially for the processing unit. The processing unit can run code written in an interpreted language such as Python. The compiled program includes a plurality of basic blocks. The basic blocks can be executed on one or more compute slices. The evaluating is based on a control flow graph (CFG). The CFG can include all possible paths that can be traversed through a compiled program. The possible paths can include decision or branch operations, conditional instructions, and so on. In embodiments, the evaluating can include identifying a sub-CFG within the CFG. The sub-CFG can include an entry basic block within the plurality of basic blocks. The entry basic block can receive control, data, and so on from another CFG, sub-CFG, and so on. In embodiments, the entry basic block can include a single entry point to the sub-CFG. The sub-CFG can further include an exit basic block within the plurality of basic blocks. In embodiments the exit basic block can include a single exit point from the sub-CFG. The sub-CFG can be evaluated such that looping within the sub-CFG is not allowed. In embodiments, the sub-CFG can form a directed acyclic graph (DAG). In embodiments, the DAG can include a Petri Net.

The system 900 can include a creating component 950. The creating component 950 can include control and functions for creating, by the compiler, a first hyperblock. The first hyperblock includes at least two basic blocks within the plurality of basic blocks that were evaluated. The at least two basic blocks can be executed in series, in parallel, or a combination of series and parallel execution. The execution of the at least two basic blocks can be based on evaluation of a branch instruction. The creating includes replacing one or more branch instructions with one or more skip instructions. The one or more skip instructions direct instruction execution between the at least two basic blocks in the first hyperblock. A skip instruction can include one or more operations. In embodiments, a first skip instruction within the one or more skip instructions can include a conditional operation. The conditional operation can be based on a logical operation, an arithmetic operation, and so on.

The system 900 can include an allocating component 960. The allocating component 960 can include control and functions for allocating a first slice task, by the control unit, to a first compute slice in the plurality of compute slices. The first slice task comprises the first hyperblock that was created by the compiler. The allocating the first hyperblock to the first compute slice can be based on slice computational resources, slice availability, and so on. In embodiments, the first compute slice can include branch prediction hardware. The branch prediction hardware can make a prediction regarding which branch path associated with a conditional operation will likely be taken prior to the evaluation of the conditional branch. Based on the branch prediction, one or more instructions can be “pre-executed” ahead of the branch evaluation. In embodiments, more than one branch path can be pre-executed. The correct path is then chosen when the branch evaluation is determined.

The system 900 can include an allotting component 970. The allotting component 970 can include control and functions for allotting a second slice task, by the control unit, to a second compute slice in the plurality of compute slices. The allotting can also be accomplished using a bus, a network, etc. The second slice task comprises at least one basic block within the plurality of basic blocks. The allotting is based on branch prediction logic within the control unit. The branch prediction logic can predict which branch path will be taken when a branch decision is made and can allot the second slice code based on that prediction. The second compute slice in the plurality of compute slices can be allotted based on a pointer. The second compute slice is coupled to the first compute slice by a first barrier register set in the plurality of barrier register sets. The first barrier register set can hold data generated by the first slice task, data required by the second slice task, etc. The first barrier register set can include one or more two-stage buffers. In a usage example, data can be loaded into the first barrier register set and can be available at the output of the first barrier register set for processing by the second slice task. Data can be generated by the first slice task as the first slice task is executed. The data generated by the first slice task can be loaded into, accumulated by, etc. an input stage of the first barrier register set. The data in the input stage of the first barrier set can be transferred to the output of the first barrier set based on a signal, a flag, and so on, such as a completion flag. The data can be transferred based on a decision such as a branch decision.

The allocating and the allotting can further be based on generating performance estimates for executing a hyperblock compared to executing the basic blocks associated with the hyperblock. Embodiments can include generating a first performance estimate, by the compiler, of executing the first hyperblock on the first compute slice. The first performance estimate can be based on computational resource utilization such as numbers of cycles, memory accesses, and so on. Embodiments can further include comparing the first performance estimate to a second performance estimate. The second performance estimate is based on executing the at least two basic blocks on the processing unit. The performance estimate for the at least two basic blocks can be based on computational resource utilization, elapsed time, etc. The executing includes at least two compute slices in the plurality of compute slices. One or more dependencies are passed between the at least two compute slices by at least one barrier register set in the plurality of barrier register sets.

The system 900 can include an initializing component 980. The initializing component 980 can include control and functions for initializing pointers. The pointers can include two or more pointers. The pointers can each point to a compute slice within the plurality of compute slices. A head pointer points to the first compute slice, and a tail pointer points to the second compute slice. The pointers can both point to the same compute slice when no compute slice blocks are loaded with slice tasks. The pointers can be updated. Embodiments can include updating the tail pointer to point to the second compute slice. In a usage example, the head pointer and the tail pointer point to the same compute slice. A first slice task can be distributed to the compute slice pointed to by the head pointer. A second slice task can be allocated to the next available compute slice that can be coupled to the first compute slice by a first barrier register set. Embodiments include updating the tail pointer to point to the second compute slice. The second compute slice can be the compute slice to which the second slice task can be allocated. Discussed below, the pointers can be updated based on completing execution of a slice task. The updating pointers can continue as further slice tasks are allocated to compute slices. Embodiments can include issuing a third slice task, by the control unit, to a third compute slice in the plurality of compute slices, wherein the issuing is based on the branch prediction logic, and wherein the third compute slice is successive to a compute slice pointed to by the tail pointer.

The system 900 can include an executing component 990. The executing component 990 can include control and functions for executing a compiled program. The program can include a plurality of slice tasks, where the slice tasks can be determined by the compiler. The slice tasks or hyperblocks that are executed, where each slice task can include at least one branch operation, can be determined based on predicted or speculative branch outcomes. In embodiments, the first hyperblock can be executed, by the first compute slice, without a prediction of the conditional operation. Recall that a first slice task can be distributed to a first compute slice, a second slice task can be allotted to a second compute slice, and so on. The executing begins at the first compute slice. While one slice task can be executed, more than one slice task can be executed in parallel. The executing a code slice can generate data for an additional slice task. The executing a slice task can determine an actual branch decision as opposed to the predicted branch decision. Execution of slice tasks that depend on the outcome of the first slice task branch decision can continue execution when the branch prediction and the branch outcome are substantially similar. Other actions can be taken if the branch prediction and the branch outcome are substantially different. Embodiments can include ignoring a result from the second compute slice, wherein a branch instruction in the first compute slice was mispredicted by the branch prediction logic. Since the branch prediction for the first compute slice was incorrectly predicted by the branch prediction logic, the slice task running on the second compute slice, which was based on the incorrectly predicted branch path of the first slice, becomes irrelevant. Further embodiments can include flushing, in the second compute slice, information stored in a write buffer. Further actions can be taken based on the branch misprediction. Embodiments can include updating the tail pointer to point to the first compute slice, wherein a next sequential slice task is not distributed to the second compute slice.

The system 900 can include a computer program product embodied in a non-transitory computer readable medium for compiling, the computer program product comprising code which causes one or more processors to generate semiconductor logic for: accessing a processing unit comprising a plurality of compute slices, a plurality of barrier register sets, a control unit, and a memory system, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices; evaluating, by the compiler, a compiled program, wherein the compiled program includes a plurality of basic blocks, wherein the evaluating is based on a control flow graph (CFG); creating, by the compiler, a first hyperblock, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock; allocating a first slice task, by the control unit, to a first compute slice in the plurality of compute slices, wherein the first slice task comprises the first hyperblock that was created by the compiler; allotting a second slice task, by the control unit, to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets; initializing pointers, wherein a head pointer points to the first compute slice, and wherein a tail pointer points to the second compute slice; and executing the compiled program, wherein the executing begins at the first compute slice.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for compiling comprising:
accessing a processing unit comprising a plurality of compute slices, a plurality of barrier register sets, a control unit, and a memory system, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices;
evaluating, by the compiler, a compiled program, wherein the compiled program includes a plurality of basic blocks, wherein the evaluating is based on a control flow graph (CFG);
creating, by the compiler, a first hyperblock, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock;
allocating a first slice task, by the control unit, to a first compute slice in the plurality of compute slices, wherein the first slice task comprises the first hyperblock that was created by the compiler;
allotting a second slice task, by the control unit, to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets;
initializing pointers, wherein a head pointer points to the first compute slice, and wherein a tail pointer points to the second compute slice; and
executing the compiled program, wherein the executing begins at the first compute slice.

2. The method of claim 1 wherein a first skip instruction within the one or more skip instructions includes a conditional operation.

3. The method of claim 2 wherein the first hyperblock is executed, by the first compute slice, without a prediction of the conditional operation.

4. The method of claim 2 wherein the first compute slice includes branch prediction hardware.

5. The method of claim 4 wherein the first hyperblock is executed, by the first compute slice, with a prediction of the conditional operation, wherein the prediction is based on the branch prediction hardware within the first compute slice.

6. The method of claim 1 further comprising generating a first performance estimate, by the compiler, of executing the first hyperblock on the first compute slice.

7. The method of claim 6 further comprising comparing the first performance estimate to a second performance estimate, wherein the second performance estimate is based on executing the at least two basic blocks on the processing unit, wherein the executing includes at least two compute slices in the plurality of compute slices, and wherein one or more dependencies are passed between the at least two compute slices by at least one barrier register set in the plurality of barrier register sets.

8. The method of claim 7 further comprising including, by the compiler, the first hyperblock in an object file, wherein the first performance estimate comprises fewer processing unit cycles than the second performance estimate.

9. The method of claim 6 wherein the first hyperblock includes an external loop, wherein the external loop is based on a branch instruction within the first hyperblock, wherein the branch instruction within the first hyperblock branches to an entry block of the first hyperblock.

10. The method of claim 9 wherein the generating includes computing a retiration interval, wherein the retiration interval comprises a difference in total processor unit cycles required to complete successive iterations of the external loop in a steady state.

11. The method of claim 10 further comprising comparing the first performance estimate to a second performance estimate, wherein the second performance estimate is based on determining a second retiration interval, wherein the second retiration interval comprises a difference in total processor unit cycles required to complete successive iterations of the external loop in a steady state, wherein the executing includes at least two compute slices in the plurality of compute slices, and wherein one or more dependencies are passed between the at least two compute slices by at least one barrier register set in the plurality of barrier register sets.

12. The method of claim 11 further comprising including, by the compiler, the first hyperblock in an object file, wherein the first performance estimate comprises fewer processing unit cycles than the second performance estimate.

13. The method of claim 1 wherein the creating includes a second hyperblock.

14. The method of claim 13 wherein the second slice task comprises the second hyperblock.

15. The method of claim 14 wherein the first hyperblock includes a first header, wherein the first header includes a number of instructions within the first hyperblock.

16. The method of claim 15 wherein the allocating includes determining, by the control unit, an end of the first hyperblock, wherein the determining is based on the number of instructions within the first hyperblock.

17. The method of claim 1 wherein the first hyperblock is included in an object file from the compiler.

18. The method of claim 1 wherein the executing includes speculatively executing the second compute slice.

19. The method of claim 1 wherein the one or more skip instructions comprise a forward branch within the first hyperblock.

20. The method of claim 1 wherein the evaluating includes identifying a sub-CFG within the CFG, wherein the sub-CFG includes an entry basic block within the plurality of basic blocks, wherein the entry basic block comprises a single entry point to the sub-CFG, wherein the sub-CFG includes an exit basic block within the plurality of basic blocks, and wherein the exit basic block comprises a single exit point from the sub-CFG.

21. The method of claim 20 further comprising selecting the exit basic block, wherein the exit basic block is based on a nearest common post-dominator of one or more successor basic blocks of the entry basic block, wherein the one or more successor basic blocks are within the sub-CFG.

22. A computer program product embodied in a non-transitory computer readable medium for compiling, the computer program product comprising code which causes one or more processors to generate semiconductor logic for:
accessing a processing unit comprising a plurality of compute slices, a plurality of barrier register sets, a control unit, and a memory system, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices;
evaluating, by the compiler, a compiled program, wherein the compiled program includes a plurality of basic blocks, wherein the evaluating is based on a control flow graph (CFG);
creating, by the compiler, a first hyperblock, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock;
allocating a first slice task, by the control unit, to a first compute slice in the plurality of compute slices, wherein the first slice task comprises the first hyperblock that was created by the compiler;
allotting a second slice task, by the control unit, to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets;
initializing pointers, wherein a head pointer points to the first compute slice, and wherein a tail pointer points to the second compute slice; and
executing the compiled program, wherein the executing begins at the first compute slice.

23. A computer system for compiling comprising:
a memory which stores instructions;
one or more processors coupled to the memory, wherein the one or more processors, when executing the instructions which are stored, are configured to:
access a processing unit comprising a plurality of compute slices, a plurality of barrier register sets, a control unit, and a memory system, wherein each compute slice within the plurality of compute slices includes at least one execution unit, is known to a compiler, and is coupled to a successor compute slice and a predecessor compute slice by a barrier register set in the plurality of barrier register sets, wherein the barrier register set provides for communication of data between successive compute slices;
evaluate, by the compiler, a compiled program, wherein the compiled program includes a plurality of basic blocks, wherein the evaluating is based on a control flow graph (CFG);
create, by the compiler, a first hyperblock, wherein the first hyperblock includes at least two basic blocks within the plurality of basic blocks that were evaluated, and wherein the creating includes replacing one or more branch instructions with one or more skip instructions, wherein the one or more skip instructions direct instruction execution between the at least two basic blocks in the first hyperblock;
allocate a first slice task, by the control unit, to a first compute slice in the plurality of compute slices, wherein the first slice task comprises the first hyperblock that was created by the compiler;
allot a second slice task, by the control unit, to a second compute slice in the plurality of compute slices, wherein the second slice task comprises at least one basic block within the plurality of basic blocks, wherein the allotting is based on branch prediction logic within the control unit, and wherein the second compute slice is coupled to the first compute slice by a first barrier register set in the plurality of barrier register sets;
initialize pointers, wherein a head pointer points to the first compute slice, and wherein a tail pointer points to the second compute slice; and
execute the compiled program, wherein the executing begins at the first compute slice.
